(19) United States
(12) Patent Application Publication
(10) Pub. No.: US 2026/0051913 A1
(43) Pub. Date: Feb. 19, 2026

(54) NOISE DETECTION DEVICE, NOISE SUPPRESSION DEVICE, NOISE DETECTION METHOD, AND RECORDING MEDIUM

(71) Applicant: Nuvoton Technology Corporation Japan, Kyoto (JP)

(72) Inventor: Seiichiro YAMAGUCHI, Osaka (JP)

(21) Appl. No.: 19/369,937

(22) Filed: Oct. 27, 2025

Related U.S. Application Data
(63) Continuation of application No. PCT/JP2024/016923, filed on May 7, 2024.
(60) Provisional application No. 63/501,048, filed on May 9, 2023.

(51) Int. Cl. H04B 1/10; H04L 27/26

(52) U.S. Cl. CPC H04B 1/10; H04L 27/265

(57) ABSTRACT

A noise detection device includes: a DFT executor that performs a DFT on an input signal and outputs a transform result; a carrier wave detector that detects a carrier wave frequency bin in the transform result; a frequency corrector that performs a correction to reduce a difference between a center frequency of the carrier wave frequency bin and a frequency of the carrier wave; a phase calculator that calculates a phase of each signal component in a corrected transform result; a phase inversion unit that inverts an order of the phase of each signal component with respect to a center frequency of the carrier wave frequency bin in the corrected transform result; and an asymmetric component detector that detects, as noise, a signal component whose phase is asymmetric with respect to the carrier wave frequency bin in the corrected transform result.

### CROSS REFERENCE TO RELATED APPLICATIONS

This is a continuation application of PCT International Patent Application No. PCT/JP2024/016923 filed on May 7, 2024, designating the United States of America, which is based on and claims priority of U.S. Provisional Patent Application No. 63/501,048 filed on May 9, 2023. The entire disclosures of the above-identified applications, including the specifications, drawings and claims are incorporated herein by reference in their entirety.

### FIELD

The present disclosure relates to a noise detection device, etc. for detecting noise contained in an input signal.

### BACKGROUND

Patent Literature (PTL) 1 discloses a noise suppression device that, in order to suppress noise with a small amount of operations, uses the symmetry in the frequency spectrum (amplitude spectrum) of the amplitude of an amplitude modulation (AM) signal to suppress, as noise, components that have no symmetry in the amplitude spectrum.

### CITATION LIST

### Patent Literature

PTL 1: Japanese Patent No. 6935425

### SUMMARY

### Technical Problem

However, with the technique disclosed in PTL 1, when the noise contained in an input signal is the noise of an inverter used in electric vehicles, etc., there are instances where the components of the noise are present in symmetric positions in an amplitude spectrum, and in such cases, unfortunately, the noise concerned cannot be detected.

In view of the above, the present disclosure provides a noise detection device, etc. capable of detecting noise even when the noise components are present at symmetric positions in an amplitude spectrum.

### Solution to Problem

A noise detection device according to the present disclosure is a noise detection device that detects noise contained in an input signal including a carrier wave and a modulation signal. The noise detection device includes: a discrete Fourier transform (DFT) executor that performs a DFT on the input signal and outputs a transform result; a carrier wave detector that detects a carrier wave frequency bin that is a frequency bin containing a component of the carrier wave in the transform result; a frequency corrector that performs a correction to reduce a difference between a center frequency of the carrier wave frequency bin and a frequency of the carrier wave; a phase calculator that calculates a phase of each signal component in a corrected transform result that is the transform result output after the correction; a phase inversion unit that inverts an order of the phase of each signal component with respect to a center frequency of the carrier wave frequency bin in the corrected transform result; and an asymmetric component detector that detects, as noise, a signal component whose phase is asymmetric with respect to the carrier wave frequency bin in the corrected transform result, based on the phase of each signal component before inversion and the phase of each signal component after inversion.

A noise suppression device according to the present disclosure includes the noise detection device described above; a suppression coefficient calculator that calculates a suppression coefficient for suppressing an amplitude of the signal component detected as the noise; and an inverse discrete Fourier transform (IDFT) executor that performs an IDFT on the corrected transform result multiplied by the suppression coefficient, and outputs an output signal.

A noise detection device according to the present disclosure is a noise detection device that detects noise contained in an input signal including a carrier wave and a modulation signal. The noise detection device includes: a discrete Fourier transform (DFT) executor that performs a DFT on the input signal and outputs a transform result; a carrier wave detector that detects a carrier wave frequency bin that is a frequency bin containing a component of the carrier wave in the transform result; a phase calculator that calculates a phase of each signal component in the transform result;
a phase inversion unit that inverts an order of the phase of each signal component with respect to a center frequency of the carrier wave frequency bin in the transform result; and an asymmetric component detector that detects, as noise, a signal component whose phase is asymmetric with respect to the center frequency of the carrier wave frequency bin in the transform result, based on the phase of each signal component before inversion and the phase of each signal component after inversion.

A noise detection method according to the present disclosure is a noise detection method performed by a noise detection device for detecting noise contained in an input signal that includes a carrier wave and a modulation signal. The noise detection method includes: performing a discrete Fourier transform (DFT) on the input signal and outputting a transform result; detecting a carrier wave frequency bin that is a frequency bin containing a component of the carrier wave in the transform result; performing a correction to reduce a difference between a center frequency of the carrier wave frequency bin and a frequency of the carrier wave; calculating a phase of each signal component in a corrected transform result that is the transform result output after the correction; inverting the phase of each signal component with respect to a center frequency of the carrier wave frequency bin in the corrected transform result; and detecting, as noise, a signal component whose phase is asymmetric with respect to the carrier wave frequency bin in the corrected transform result, based on the phase of each signal component before inversion and the phase of each signal component after inversion.

A recording medium according to the present disclosure is a non-transitory computer-readable recording medium having recorded thereon a computer program for causing a computer to execute the noise detection method described above.

General and specific aspects described above may be implemented using a system, a method, an integrated circuit, a computer program, or a computer-readable recording medium such as a compact disc read only memory (CD-ROM), or any combination of systems, methods, integrated circuits, computer programs, or computer-readable recording media.

### Advantageous Effects

With the noise detection device, etc. according to one aspect of the present disclosure, it is possible to detect noise even when the noise components are present at symmetric positions in an amplitude spectrum.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating an example of a noise suppression device according to Embodiment 1.

FIG. 2 is a diagram for explaining an operation of a carrier wave detector.

FIG. 3 is a diagram for explaining an operation of a frequency corrector.

FIG. 4 is a diagram schematically illustrating the correction to reduce the difference between the center frequency of a carrier wave frequency bin and the frequency of the carrier wave.

FIG. 5 is a diagram illustrating that the phase of a modulation component is symmetric with respect to the center frequency of the carrier wave frequency bin as a result of correction.

FIG. 6 is a diagram for explaining an operation of a noise suppression device according to Embodiment 1.

FIG. 7 is a block diagram illustrating an example of a noise suppression device according to Embodiment 2.

FIG. 8 is a block diagram illustrating an example of a noise suppression device according to Embodiment 3.

FIG. 9 is a block diagram illustrating an example of a noise suppression device according to Embodiment 4.

FIG. 10 is a block diagram illustrating an example of a noise suppression device according to Embodiment 5.

FIG. 11 is a block diagram illustrating an example of a noise detection device according to other embodiments.

FIG. 12 is a flowchart illustrating an example of a noise detection method according to other embodiments.

### DESCRIPTION OF EMBODIMENTS

Hereinafter, embodiments will be described in detail with reference to the Drawings.

It should be noted that the embodiments described below each show a general or specific example. The numerical values, shapes, materials, structural components, the arrangement and connection of the structural components, steps, the processing order of the steps, and so on, indicated in the following embodiments are mere examples, and therefore do not limit the present disclosure.

### Embodiment 1

Hereinafter, a noise detection device and a noise suppression device according to Embodiment 1 will be described.

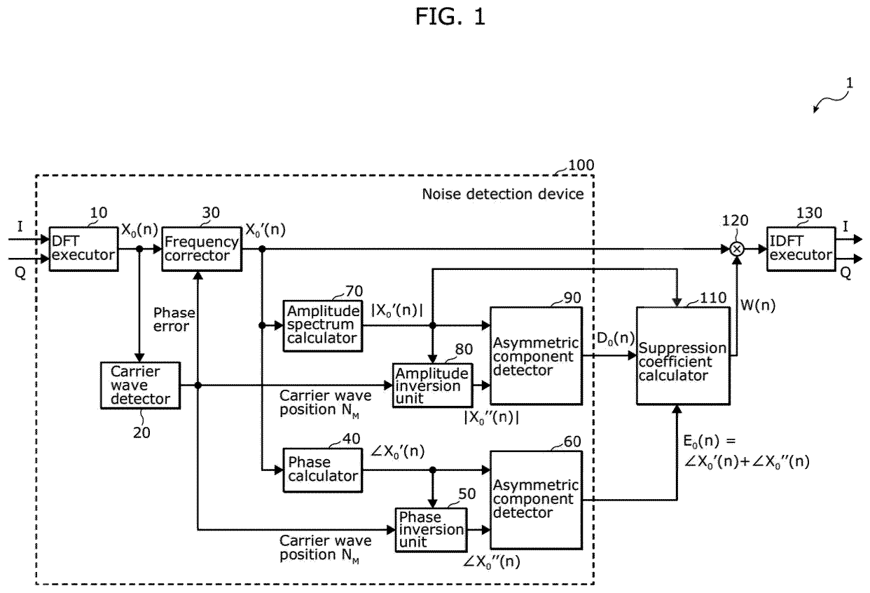

FIG. 1 is a block diagram illustrating an example of noise suppression device 1 according to Embodiment 1.

Noise suppression device 1 is a device for suppressing noise contained in an input signal (e.g., I/Q signal) including a carrier wave and a modulation signal. For example, the input signal is a broadcast wave. For example, a modulation processing is performed on an output signal (input signal with noise suppressed) output from noise suppression device 1.

Noise suppression device 1 includes noise detection device 100, suppression coefficient calculator 110, multiplier 120, and inverse discrete Fourier transform (IDFT) executor 130.

Noise detection device 100 is a device for detecting noise contained in an input signal. Noise suppression device 1 is capable of suppressing noise contained in an input signal as a result of detecting the noise contained in the input signal by noise detection device 100.

Noise detection device 100 includes discrete Fourier transform (DFT) executor 10, carrier wave detector 20, frequency corrector 30, phase calculator 40, phase inversion unit 50, asymmetric component detector 60, amplitude spectrum calculator 70, amplitude inversion unit 80, and asymmetric component detector 90. Noise detection device 100 is a computer including a processor (microprocessor), memory, and the like. Memory is read only memory (ROM), random access memory (RAM), or the like, and is capable of storing programs executed by a processor. DFT executor 10, carrier wave detector 20, frequency corrector 30, phase calculator 40, phase inversion unit 50, asymmetric component detector 60, amplitude spectrum calculator 70, amplitude inversion unit 80, and asymmetric component detector 90 are each implemented, for example, by a processor that executes the programs stored in memory. It should be noted that suppression coefficient calculator 110, multiplier 120, and IDFT executor 130 are also each implemented, for example, by a processor that executes the programs stored in memory. For example, a single computer may implement: DFT executor 10, carrier wave detector 20, frequency corrector 30, phase calculator 40, phase inversion unit 50, asymmetric component detector 60, amplitude spectrum calculator 70, amplitude inversion unit 80, and asymmetric component detector 90 which are functional sections of noise detection device 100; suppression coefficient calculator 110, multiplier 120, and IDFT executor 130.

DFT executor 10 performs discrete Fourier transform (DFT) on an input signal and outputs a transform result (frequency spectrum).

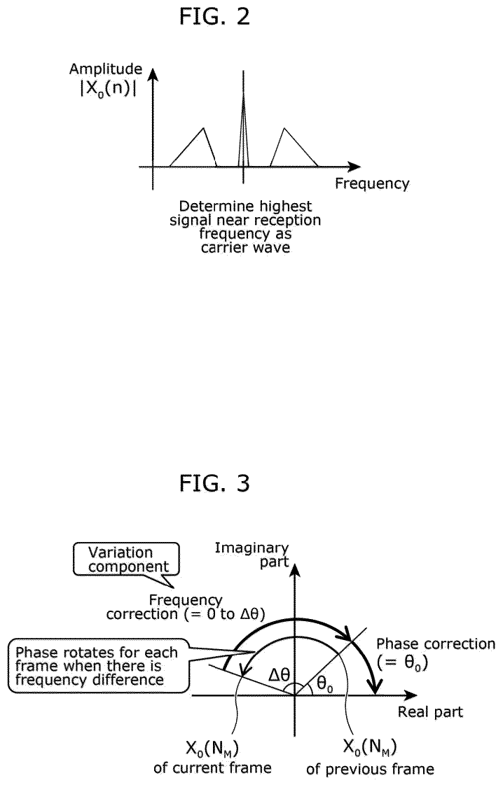

Carrier wave detector 20 detects a carrier wave frequency bin that is a frequency bin containing a component of a carrier wave in the transform result of DFT executor 10. An operation of carrier wave detector 20 will be described with reference to FIG. 2.

FIG. 2 is a diagram for explaining an operation of carrier wave detector 20. FIG. 2 illustrates the amplitude spectrum of an input signal. For example, as illustrated in FIG. 2, carrier wave detector 20 determines, as the carrier wave, the component with a highest amplitude near a reception frequency in the amplitude spectrum. Carrier wave detector 20 may determine, as the carrier wave, a signal that has been continuously determined as a carrier wave. For example, even when noise with high amplitude appears locally near the reception frequency, carrier wave detector 20 is capable of determining, as a carrier wave, not the noise but a signal that has been determined as a carrier wave. In addition, carrier wave detector 20 detects a frequency bin containing a component of a carrier wave as the carrier wave frequency bin. Carrier wave detector 20 outputs a position (frequency) of the carrier wave detected to phase inversion unit 50 and amplitude inversion unit 80.

In addition, for example, carrier wave detector 20 detects a phase of the carrier wave in the transform result of DFT executor 10. More specifically, carrier wave detector 20 detects the phase of the carrier wave for each frame. When the phase of the carrier wave changes from frame to frame, carrier wave detector 20 outputs a phase error that is an amount of change in the phase of the carrier wave between frames, to frequency corrector 30.

Frequency corrector 30 performs a correction to reduce the difference between the center frequency of the carrier wave frequency bin and the frequency of the carrier wave. An operation of frequency corrector 30 will be described with reference to FIG. 3.

FIG. 3 is a diagram for explaining an operation of frequency corrector 30. FIG. 3 illustrates the complex notation of the components of the carrier wave frequency bin. For example, frequency corrector 30 performs the above-described correction based the phase of the carrier wave detected by carrier wave detector 20. More specifically, frequency corrector 30 performs the above-described correction by performing a convolution operation based on the phase of the carrier wave on the transform result of DFT executor 10.

When there is a difference between the center frequency of the carrier wave frequency bin and the frequency of the carrier wave, as illustrated in FIG. 3, the phase rotates for each frame; that is, a phase error occurs. As a result, the phase error is output from carrier wave detector 20 to frequency corrector 30. Frequency corrector 30 performs a convolution operation to correct the phase of the carrier wave of the current frame in order to reduce the phase error (e.g., to 0). More specifically, when the phase error is Δθ, frequency corrector 30 performs a convolution operation to correct the phase of the carrier wave of the current frame by 0 to Δθ. In this manner, it is possible to reduce the difference between the center frequency of the carrier wave frequency bin and the frequency of the carrier wave.

As described above, when the carrier wave frequency bin deviates from the actual frequency of the carrier wave, the component rotates (i.e., a phase error occurs) for each frame when the carrier wave frequency bin is displayed in complex notation. In view of the above, by detecting the phase of the carrier wave and performing correction to inhibit a phase error, it is possible to reduce the difference between the center frequency of the carrier wave frequency bin and the frequency of the carrier wave. For example, by performing a convolution operation in the frequency domain, it is possible to perform correction to inhibit a phase error.

Frequency corrector 30 may perform a convolution operation to correct the phase of the carrier wave of the current frame in order to also reduce the argument (θ₀ indicated in FIG. 3) of the phase of the carrier wave to a small value (e.g., to 0). By doing so, it is possible to also fix the argument, for example, to 0°.

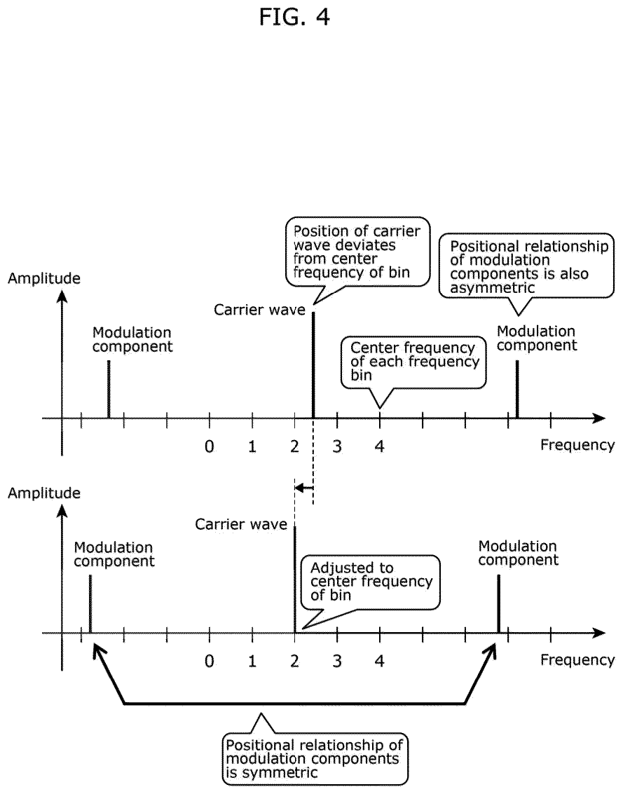

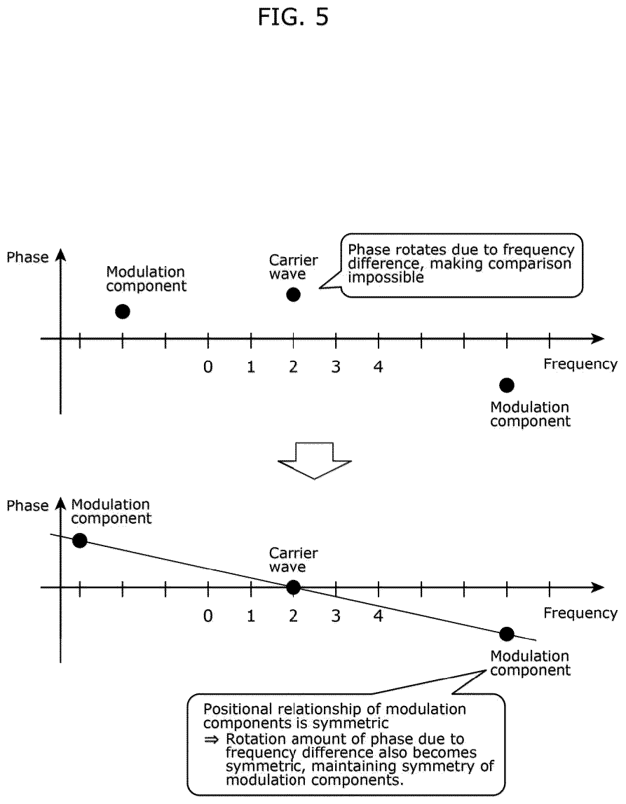

Here, the reason for making the above-described correction will be described with reference to FIG. 4 and FIG. 5.

FIG. 4 is a diagram schematically illustrating the correction to reduce the difference between the center frequency of a carrier wave frequency bin and the frequency of the carrier wave. FIG. 4 illustrates the amplitude spectrum of input signals.

FIG. 5 is a diagram illustrating that the phase of a modulation component becomes symmetric with respect to the center frequency of the carrier wave frequency bin as a result of correction. FIG. 5 illustrates the phase spectrum of an input signal.

Depending on the frequency resolution of a DFT, the carrier wave frequency bin in the transform result of the DFT deviates from the actual frequency of the carrier wave. As illustrated in the upper side of FIG. 4, when the frequency indicated by “2” is taken as the center frequency of the carrier wave frequency bin, it can be seen that the carrier wave frequency bin deviates from the actual frequency of the carrier wave. Accordingly, as illustrated in the upper side of FIG. 4, the components of the modulation signals are not symmetric in terms of amplitude with respect to the carrier wave frequency bin. As a result, it becomes impossible to compare the amplitudes before and after inversion of the amplitude spectrum by amplitude spectrum calculator 70, amplitude inversion unit 80, and asymmetric component detector 90 that will be described later. In addition, as illustrated in the upper side of FIG. 5, due to the influence of the frequency difference, the phase rotates as illustrated in FIG. 3, and thus the components of the modulation signals are not symmetric in terms of phases with respect to the carrier wave frequency bin. Therefore, it becomes impossible to compare the phases before and after inversion of the phase spectrum by phase calculator 40, phase inversion unit 50, and asymmetric component detector 60 that will be described later. More specifically, since an amplitude is a scalar quantity, it is possible to compare the amplitudes by allowing the deviation in the frequency direction, as described in PTL 1. On the other hand, a phase is an angular component, and the phase of each frequency bin indicates a different value depending on the difference between the frequency of each frequency bin and the frequency of a signal. For this reason, unlike an amplitude, it is not possible to compare the phases by allowing a deviation in the frequency direction.

In view of the above, by performing the above-described correction, the components of the modulation signals become symmetric in terms of amplitudes with respect to the carrier wave frequency bin, as illustrated in the lower side of FIG. 4. In addition, as illustrated in the lower side of FIG. 5, the rotation amounts of phases due to the frequency difference also become symmetric, and the components of the modulation signals become symmetric in terms of phase with respect to the carrier wave frequency bin.

Returning to the explanation in FIG. 1, frequency corrector 30 outputs a corrected transform result that is a transform result of DFT executor 10 after correction, to phase calculator 40 and amplitude spectrum calculator 70. In addition, frequency corrector 30 outputs the corrected transform result to outside noise detection device 100 (e.g., multiplier 120).

Phase calculator 40 calculates the phase of each signal component in the corrected transform result that is the transform result of DFT executor 10 output after correction. Each signal component may contain a component of noise in addition to a component of a carrier wave and a component of a modulation signal. Phase calculator 40 outputs the calculated phase of each signal component to phase inversion unit 50 and asymmetric component detector 60.

Phase inversion unit 50 inverts the order of the phase of each signal component with respect to the center frequency of the carrier wave frequency bin in the corrected transform result. Phase inversion unit 50 outputs the inverted phase of each signal component to asymmetric component detector 60.

Asymmetric component detector 60 detects, as noise, a signal component whose phase is asymmetric with respect to the carrier wave frequency bin in the corrected transform result, based on the phase before inversion (specifically, the phase output from phase calculator 40) and the phase after inversion (specifically, the phase output from phase inversion unit 50) of each signal component.

Amplitude spectrum calculator 70 calculates the amplitude of each signal component in the corrected transform result. Amplitude spectrum calculator 70 outputs the calculated amplitude of each signal component to amplitude inversion unit 80 and asymmetric component detector 90.

Amplitude inversion unit 80 inverts the order of the amplitude of each signal component with respect to the center frequency of the carrier wave frequency bin in the corrected transform result. Amplitude inversion unit 80 outputs the inverted amplitude of each signal component to asymmetric component detector 90.

Asymmetric component detector 90 detects, as noise, a signal component whose amplitude is asymmetric with respect to the carrier wave frequency bin in the corrected transform result, based on the amplitude of each signal component before inversion (specifically, the amplitude output from amplitude spectrum calculator 70) and the amplitude of each signal component after inversion (specifically, the amplitude output from amplitude inversion unit 80).

Suppression coefficient calculator 110 calculates a suppression coefficient for suppressing the amplitude of the signal component detected as noise.

Multiplier 120 multiplies the corrected transform result by the suppression coefficient. As a result, noise is suppressed.

IDFT executor 130 performs an inverse discrete Fourier transform (IDFT) on the corrected transform result multiplied by the suppression coefficient, and outputs an output signal.

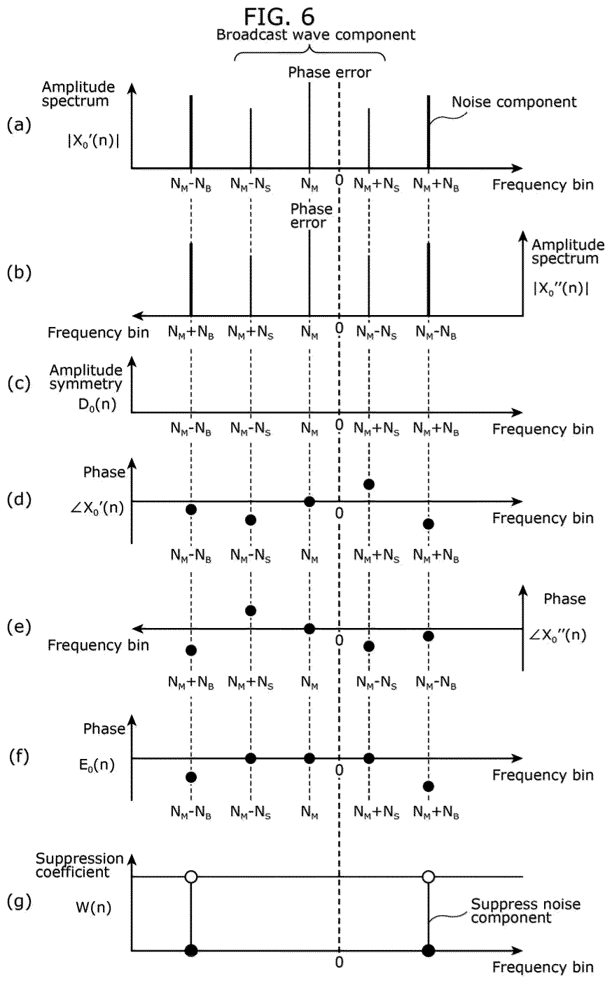

Here, a specific example of the operation of noise suppression device 1 will be described with reference to FIG. 6.

FIG. 6 is a diagram for explaining an operation of noise suppression device 1 according to Embodiment 1. In FIG. 6, (a) illustrates the output (|X₀′(n)|) of amplitude spectrum calculator 70. In FIG. 6, (b) illustrates the output (|X₀″(n)|) of amplitude inversion unit 80. In FIG. 6, (c) illustrates the output (D₀(n)) of asymmetric component detector 90. In FIG. 6, (d) illustrates the output (∠X₀′(n)) of phase calculator 40. In FIG. 6, (e) illustrates the output (∠X₀″(n)) of phase inversion unit 50. In FIG. 6, (f) illustrates the output (E₀(n)) of asymmetric component detector 60. In FIG. 6, (g) illustrates the output (W (n)) of suppression coefficient calculator 110.

As illustrated in (a) of FIG. 6, it can be seen that, due to the correction by frequency corrector 30, broadcast wave components (components of modulation signals) are symmetric in terms of amplitude between frequency N_{M}−N_{S} and frequency N_{M}+N_{S} with respect to the carrier wave frequency bin N_{M}. It should be noted that there are instances where noise components are also symmetric in terms of amplitude with respect to the carrier wave frequency bin. In the explanation of FIG. 6, it is assumed that the amplitudes of the noise components are symmetric between frequency N_{M}−N_{B} and frequency N_{M}+N_{B} with respect to the carrier wave frequency bin N_{M}.

As illustrated in (b) of FIG. 6, it can be seen that the amplitude of each signal component is inverted with respect to the center frequency of the carrier wave frequency bin in the amplitude spectrum by amplitude inversion unit 80.

For example, asymmetric component detector 90 detects a signal component whose amplitude is asymmetric, by calculating the difference between the amplitude spectrum before inversion and the amplitude spectrum after inversion. As illustrated in (a) and (b) of FIG. 6), each signal component has an amplitude that is symmetric with respect to the carrier wave frequency bin, and thus the difference is 0, as indicated in (c) of FIG. 6. For this reason, when the amplitudes of the noise components are symmetric with respect to the carrier wave frequency bin, asymmetric component detector 90 cannot detect the noise.

It should be noted that, when the amplitudes of the noise components are not symmetric with respect to the carrier wave frequency bin, asymmetric component detector 90 can detect the noise. Details of the noise detection method when the amplitudes of the noise components are not symmetric with respect to the carrier wave frequency bin (i.e., details of the operations of amplitude spectrum calculator 70, amplitude inversion unit 80, and asymmetric component detector 90) are described in PTL 1, and thus the explanation will be omitted.

As illustrated in (d) of FIG. 6, it can be seen that, due to the correction by frequency corrector 30, the broadcast wave components (the components of the modulation signals) are symmetric in terms of phase between frequency N_{M}−N_{S} and frequency N_{M}+N_{S} with respect to the carrier wave frequency bin N_{M}. It should be noted that noise is a signal that is not synchronized with the carrier wave, and thus even if the amplitudes are symmetric, the phases are asymmetric.

As illustrated in (e) of FIG. 6, it can be seen that the phase of each signal component is inverted with respect to the center frequency of the carrier wave frequency bin in the phase spectrum by phase inversion unit 50.

For example, asymmetric component detector 60 detects a signal component whose phase is asymmetric, by calculating the difference between the phase spectrum before inversion and the phase spectrum after inversion. As illustrated in (d) and (e) of FIG. (6), the components of modulation signals are symmetric in terms of phase with respect to the carrier wave frequency bin, and thus the difference is 0, as indicated in (f) of FIG. 6. On the other hand, since the noise components are asymmetric in terms of phase with respect to the carrier wave frequency bin, the absolute value of the difference becomes greater than 0, as indicated in (f) of FIG. 6. Therefore, even when the noise components are symmetric in terms of amplitude with respect to the carrier wave frequency bin, asymmetric component detector 60 can detect the noise.

Suppression coefficient calculator 110 calculates a suppression coefficient for suppressing the amplitude of the signal component detected as noise, for each position (frequency) of the detected noise. The method for calculating the suppression coefficient is not particularly limited, but a suppression coefficient is calculated such that the amplitude of the signal component detected as noise in the amplitude spectrum becomes small (e.g., 0). Then, by multiplying the corrected transform result by the calculated suppression coefficient, it is possible to suppress the noise contained in the input signal.

As described above, in the transform result (frequency spectrum) of the DFT on input signals, the components of modulation signals are ideally symmetric in terms of amplitude and phase with respect to the carrier wave frequency bin. On the other hand, although there are instances where noise components are symmetric in terms of amplitude with respect to the carrier wave frequency bin, the noise components are asymmetric in terms of phase even when they are symmetric in terms of amplitude since noise is a signal that is not synchronized with the carrier wave. In view of the above, with noise detection device 100, it is possible to detect, as noise, a signal component whose phase is asymmetric with respect to the carrier wave frequency bin, by inverting the phase of each signal component which may include noise, with respect to the center frequency of the carrier wave frequency bin in the transform result, and comparing the phase of each signal component before inversion with the phase of each signal component after inversion. As a result, it is possible to detect noise even when the noise components are present at symmetric positions in the amplitude spectrum.

However, depending on the frequency resolution of a DFT, the carrier wave frequency bin in the transform result of the DFT deviates from the actual frequency of the carrier wave. When the carrier wave frequency bin deviates from the actual frequency of the carrier wave, the components of the modulation signals are not symmetric in terms of phase with respect to the carrier wave frequency bin. As a result, the components of the modulation signals also are asymmetric in terms phase with respect to the carrier wave frequency bin, which may lead to the components of the modulation signals being falsely detected as noise. In view of the above, by performing correction to reduce the difference between the center frequency of the carrier wave frequency bin and the frequency of the carrier wave, it is possible to reduce the deviation between the carrier wave frequency bin and the actual frequency of the carrier wave. As a result, it is possible to inhibit the components of the modulation signals from becoming asymmetric in terms of phase with respect to the carrier wave frequency bin, making it possible to inhibit the components of the modulation signals from being falsely detected as noise.

For example, as a noise countermeasure for inverters used in electric vehicles, etc., there is a method of detecting, as noise, a component appearing in an orthogonal component, by utilizing the fact that the components of broadcast signals are concentrated in the in-phase component when an AM signal is synchronously detected, as described in U.S. Pat. No. 11,277,287. However, this method requires a low-pass filter (LPF) or a phase lock loop (PLL) to extract the carrier wave for synchronous detection, leading to an increase in processing costs. On the other hand, according to the present disclosure, since correction is performed by calculation from the carrier wave detected by a DFT, an LPF or a PLL is not required, making it possible to reduce processing costs.

In addition, with noise suppression device 1, it is possible to detect noise contained in an input signal, and output an output signal with noise suppressed. For example, even in the cases where it is difficult to detect a carrier wave, such as when there is significant noise in proximity to the frequency of a carrier wave or when a sudden large pulse noise is applied, it is possible to achieve suppression equivalent to that of conventional methods, by suppressing only the detection portion of an amplitude difference, thereby making it possible to suppress a decrease in the suppression function.

### Embodiment 2

Next, a noise detection device and a noise suppression device according to Embodiment 2 will be described.

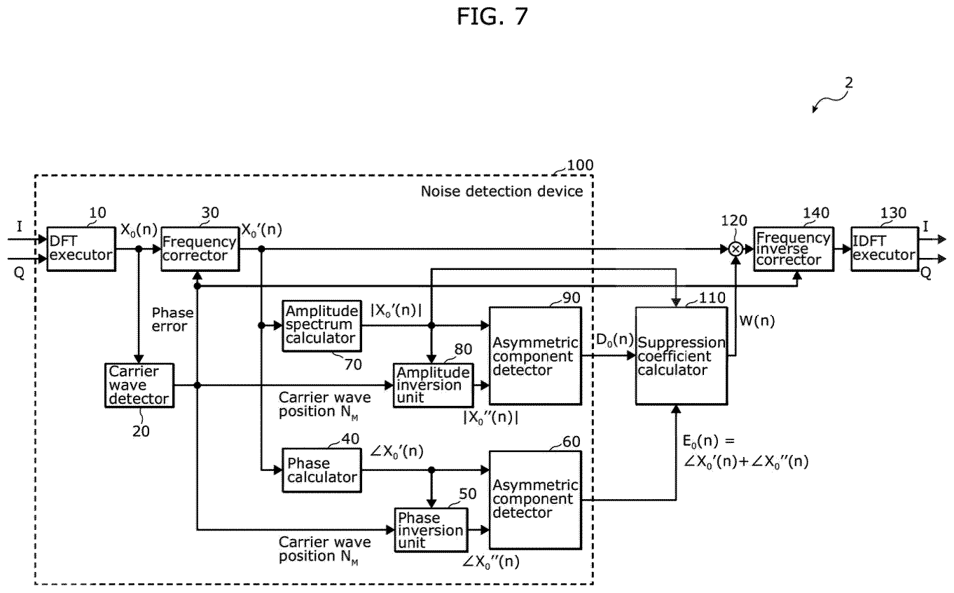

FIG. 7 is a block diagram illustrating an example of noise suppression device 2 according to Embodiment 2.

Noise suppression device 2 differs from noise suppression device 1 according to Embodiment 1 in that noise suppression device 2 further includes frequency inverse corrector 140. The following description focuses on the differences from Embodiment 1, and descriptions for the same points will be omitted.

Frequency inverse corrector 140 performs inverse correction to reverts the difference between the center frequency of the carrier wave frequency bin in the corrected transform result multiplied by a suppression coefficient and the frequency of a carrier wave, back to the state before the correction was performed. Frequency inverse corrector 140 is capable of performing inverse correction by obtaining a phase error used in the correction performed by frequency corrector 30 from carrier wave detector 20.

There are instances where a signal variation occurs due to a variation in the correction amount of the correction by frequency corrector 30. However, by performing inverse correction of the correction, it is possible to suppress the effects of such signal variation. In addition, when the frame length and the data processing unit do not match, there are instances where the phase rotates depending on the carrier position. For example, when performing fast Fourier transformation (FFT) with a shift of ½ frame, if the carrier position deviates by 1 bin from the center, the data of the next frame starts from a position rotated by ½×360°, and thus the phase appears to rotate by 180° for each frame. In this case, when the phase of the carrier wave frequency bin is aligned to 0°, the phase is inverted for each frame at the time of coupling after the IDFT. Accordingly, it is not possible to perform coupling correctly. Even in such a case, it is possible to couple the signals correctly by performing inverse correction by frequency inverse corrector 140.

### Embodiment 3

Next, a noise detection device and a noise suppression device according to Embodiment 3 will be described.

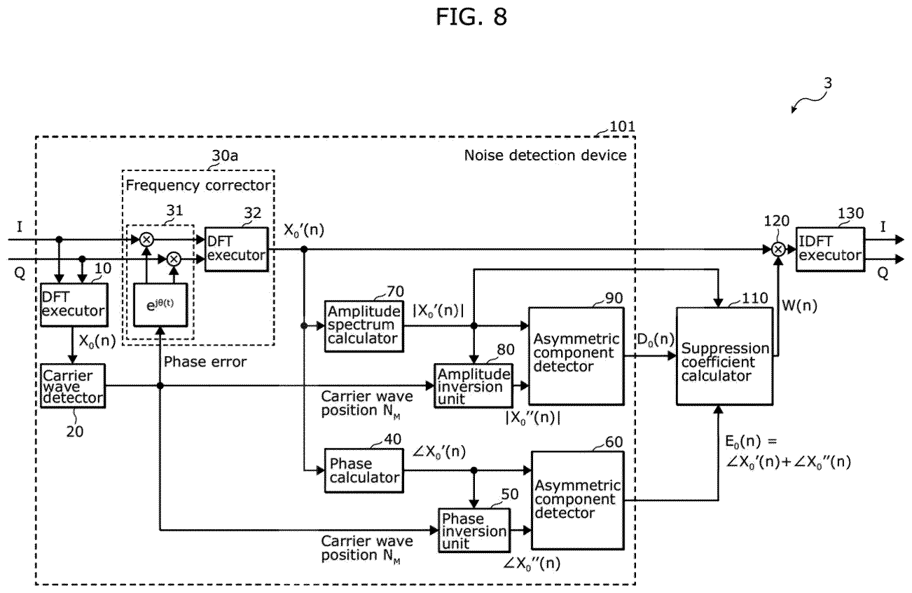

FIG. 8 is a block diagram illustrating an example of noise suppression device 3 according to Embodiment 3.

Noise suppression device 3 differs from noise suppression device 1 according to Embodiment 1 in that noise suppression device 3 includes noise detection device 101 in place of noise detection device 100. In addition, noise detection device 101 differs from noise detection device 100 according to Embodiment 1 in that noise detection device 101 includes frequency corrector 30a in place of frequency corrector 30, and that an input signal is input to frequency corrector 30a without involving DFT executor 10. The following description focuses on the differences from Embodiment 1, and descriptions for the same points will be omitted.

Frequency corrector 30a includes phase adjuster 31 and DFT executor 32.

Phase adjuster 31 adjusts the phase of an input signal to reduce the phase of the carrier wave, and DFT executor 32 executes DFT on the input signal whose phase has been adjusted such that the phase of the carrier wave is reduced, and outputs a transform result. Frequency corrector 30a (DFT executor 32) outputs a corrected transform result that is a transform result of DFT executor 32 after correction, to phase calculator 40 and amplitude spectrum calculator 70. Here, the adjustment of the phase of an input signal performed by phase adjuster 31 will be explained again with reference to FIG. 3.

Phase adjuster 31 adjusts the phase of an input signal based the phase of the carrier wave detected by carrier wave detector 20. When there is a difference between the center frequency of the carrier wave frequency bin and the frequency of the carrier wave, as illustrated in FIG. 3, the phase rotates for each frame; that is, a phase error occurs. As a result, the phase error is output from carrier wave detector 20 to phase adjuster 31. Then, phase adjuster 31 adjusts the phase of the input signal to correct the phase of the carrier wave of the current frame in order to reduce the phase error (e.g., to 0). More specifically, when the phase error is Δθ, phase adjuster 31 adjusts the phase of the input signal by an angle of θ(t)=Δθ×t/T. Here, T is the period of the input signal. In this manner, correction can be performed to inhibit a phase error, and thus it is possible to reduce the difference between the center frequency of the carrier wave frequency bin and the frequency of the carrier wave.

As described above, it is possible to perform correction to inhibit a phase error, by adjusting the phase of the input signal in the time domain.

Phase adjuster 31 may adjust the phase of an input signal to correct the phase of the carrier wave of the current frame in order to also reduce the argument (θ₀ indicated in FIG. 3) of the phase of the carrier wave (e.g., to zero). More specifically, phase adjuster 31 may adjust the phase of the input signal by an angle of θ(t)=Δθ×t/T+θ₀. By doing so, it is also possible to fix the argument, for example, to 0°.

As described above, even when the transform result of DFT executor 10 is not input and the input signal is input to frequency corrector 30a, frequency corrector 30a is capable of performing correction to reduce the difference between the center frequency of the carrier wave frequency bin and the frequency of the carrier wave.

It should be noted that, in noise suppression device 3, frequency inversion correction may be performed in the time domain after an IDFT is executed by IDFT executor 130.

### Embodiment 4

Next, a noise detection device and a noise suppression device according to Embodiment 4 will be described.

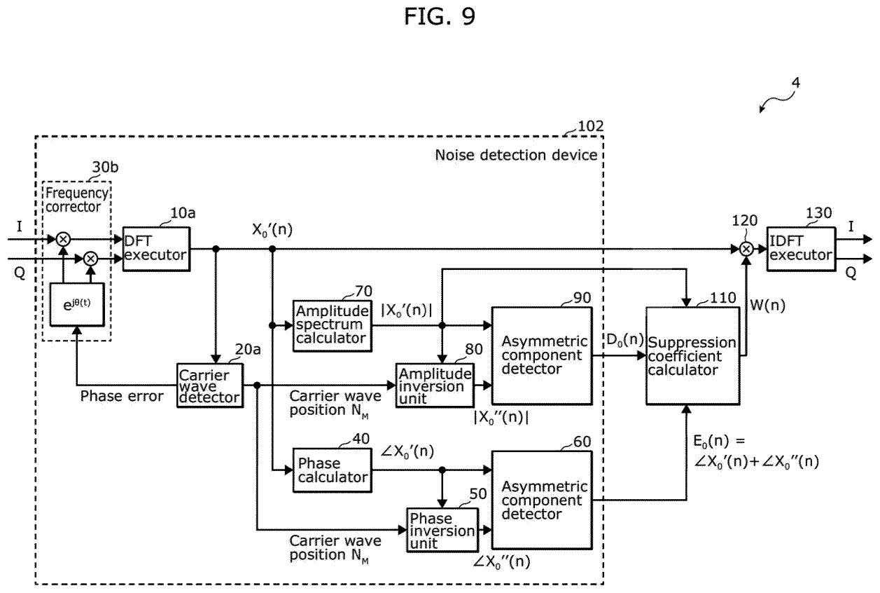

FIG. 9 is a block diagram illustrating an example of noise suppression device 4 according to Embodiment 4.

Noise suppression device 4 differs from noise suppression device 1 according to Embodiment 1 in that noise suppression device 4 includes noise detection device 102 in place of noise detection device 100. In addition, noise detection device 102 differs from noise detection device 100 according to Embodiment 1 in that frequency corrector 30b, DFT executor 10a, and carrier wave detector 20a are included in place of frequency corrector 30, DFT executor 10, and carrier wave detector 20, and that an input signal is input to frequency corrector 30b and a corrected input signal is input to DFT executor 10a. The following description focuses on the differences from Embodiment 1, and descriptions for the same points will be omitted.

Frequency corrector 30b performs a correction to reduce the difference between the center frequency of the carrier wave frequency bin and the frequency of the carrier wave, by adjusting the phase of an input signal to reduce the phase of the carrier wave. DFT executor 10a performs a discrete Fourier transform on the input signal whose phase has been adjusted by the above-described correction. Carrier wave detector 20a detects a carrier wave frequency bin in the corrected transform result, and detects the phase of the carrier wave after subtracting an amount of phase adjustment resulting from the above-described correction.

The amount of phase adjustment of the input signal in the time domain in frequency corrector 30b is information obtained by calculation in noise detection device 102, and thus the processing in frequency corrector 30b is performed before the processing in DFT executor 10a, and when detecting the phase (specifically, the phase error) by carrier wave detector 20a, the amount of phase adjustment in frequency corrector 30b is subtracted, thereby making it possible to unify the DFT executor used for detecting a carrier wave and the DFT executor used for detecting noise In other words, in noise detection device 102 according to Embodiment 4, unlike noise detection device 101 according to Embodiment 3, there is no need to separately provide DFT executor 10 and DFT executor 32, and thus it is possible to reduce the processing costs.

### Embodiment 5

Next, a noise detection device and a noise suppression device according to Embodiment 5 will be described.

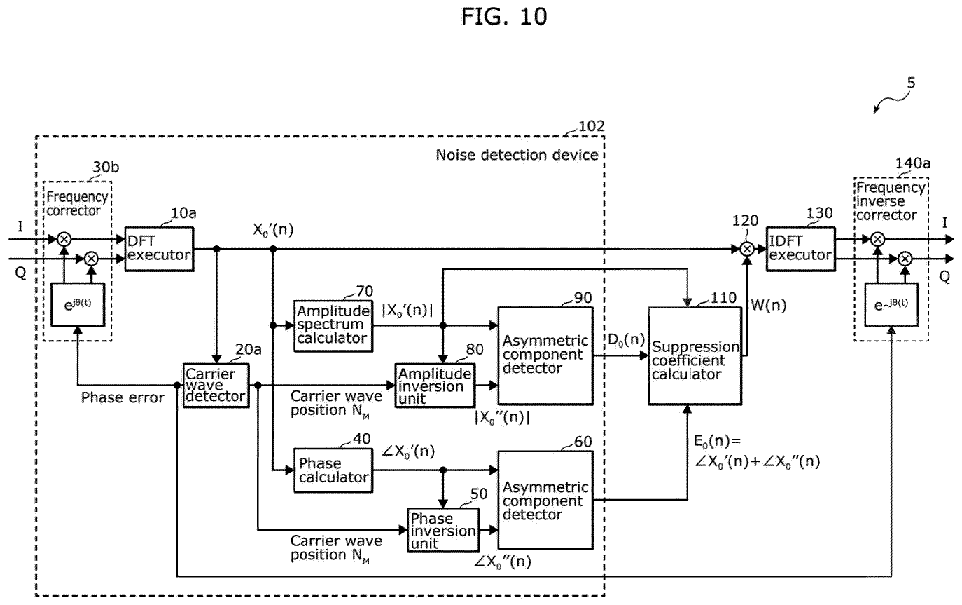

FIG. 10 is a block diagram illustrating an example of noise suppression device 5 according to Embodiment 5.

Noise suppression device 5 differs from noise suppression device 4 according to Embodiment 4 in that noise suppression device 5 further includes frequency inverse corrector 140a. The following description focuses on the differences from Embodiment 4, and descriptions for the same points will be omitted.

Frequency inverse corrector 140a performs inverse correction to reverts the difference between the center frequency of the carrier wave frequency bin in the corrected transform result multiplied by a suppression coefficient and the frequency of a carrier wave, back to the state before the correction was performed. Frequency inverse corrector 140a is capable of performing inverse correction by obtaining a phase error used in the correction performed by frequency corrector 30b from carrier wave detector 20a. The advantageous effect yielded by providing frequency inverse corrector 140a is the same as the advantageous effect yielded by providing frequency inverse corrector 140.

### Other Embodiments

Embodiments are described thus far as exemplifications of the technique according to the present disclosure. However, the technique according to the present disclosure is not limited to the foregoing embodiments, and can also be applied to embodiments to which a change, substitution, addition, or omission is executed as necessary. For example, the following variation examples are also included in one embodiment of the present disclosure.

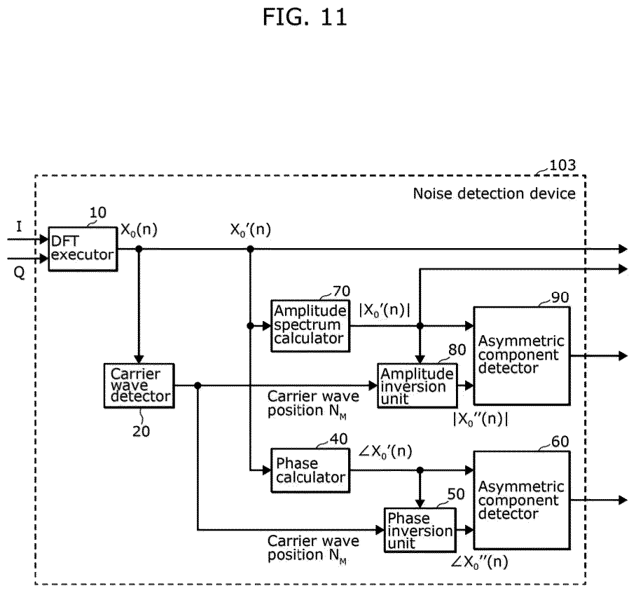

For example, although an example has been described in which the noise detection device includes the frequency corrector in the foregoing embodiments, the frequency corrector need not necessarily be included as illustrated in FIG. 11.

FIG. 11 is a block diagram illustrating an example of noise detection device 103 according to other embodiments.

Noise detection device 103 differs from noise detection device 100 according to Embodiment 1 in that noise detection device 103 does not include frequency corrector 30. In addition, phase calculator 40 calculates the phase of each signal component in the transform result, phase inversion unit 50 inverts the order of the phase of each signal component with respect to the center frequency of the carrier wave frequency bin in the transform result, and asymmetric component detector 60 detects, as noise, a signal component whose phase is asymmetric with respect to the center frequency of the carrier wave frequency bin in the transform result, based on the phase before inversion and the phase after inversion of each signal component. In other words, in Embodiment 1, phase calculator 40, phase inversion unit 50, and asymmetric component detector 60 perform processing using the corrected transform result, but in Embodiment 3, since noise detection device 103 does not include frequency corrector 30, phase calculator 40, phase inversion unit 50, and asymmetric component detector 60 perform processing using the transform result that has not been corrected by frequency corrector 30. The other points are the same as those described in Embodiment 1, and thus the description will be omitted.

When the frequency resolution of a DFT (sampling frequency/total number of sampling points) by DFT executor 10 is fine, the deviation between the carrier wave frequency bin in the transform result by the DFT and the actual frequency of the carrier wave is small, and thus the frequency corrector is not necessary. For example, the noise detection device according to Embodiments 1 to 5 may be replaced by noise detection device 103.

For example, in the foregoing embodiment, an example has been described in which a noise detection device includes amplitude spectrum calculator 70, amplitude inversion unit 80, and asymmetric component detector 90, but the noise detection device need not necessarily include amplitude spectrum calculator 70, amplitude inversion unit 80, and asymmetric component detector 90.

For example, the present disclosure can be implemented not only as a noise detection device or a noise suppression device, but also as a noise detection method that includes steps (processes) performed by the structural components constituting the noise detection device.

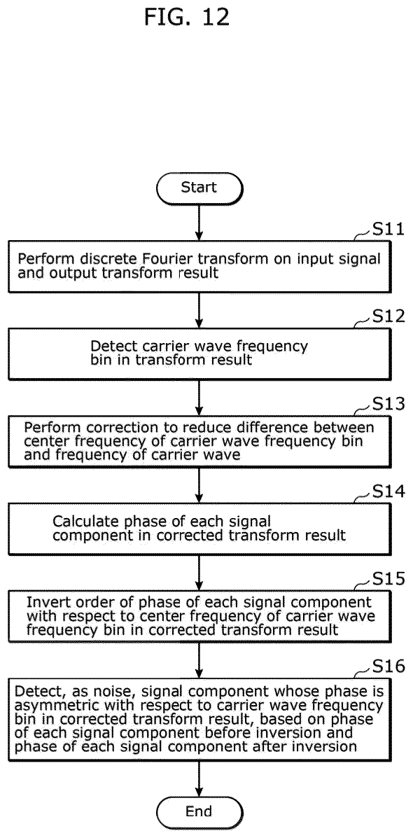

FIG. 12 is a flowchart illustrating an example of a noise detection method according to other embodiments.

The noise detection method is a noise detection method that is executed by a noise detection device for detecting noise contained in an input signal that includes a carrier wave and a modulation signal. The noise detection method, as illustrated in FIG. 12, includes: performing a discrete Fourier transform (DFT) on the input signal and outputting a transform result (step S11); detecting a carrier wave frequency bin that is a frequency bin containing a component of the carrier wave in the transform result (step S12); performing a correction to reduce a difference between a center frequency of the carrier wave frequency bin and a frequency of the carrier wave (step S13); calculating a phase of each signal component in a corrected transform result that is the transform result output after the correction (step S14); inverting the phase of each signal component with respect to a center frequency of the carrier wave frequency bin in the corrected transform result (step S15); and detecting, as noise, a signal component whose phase is asymmetric with respect to the carrier wave frequency bin in the corrected transform result, based on the phase of each signal component before inversion and the phase of each signal component after inversion (step S16).

For example, the present disclosure may be implemented as a program for causing a computer (processor) to execute the steps included in the noise detection method. In addition, the present disclosure can be implemented as a non-transitory computer-readable recording medium such as a compact disc-read only memory (CD-ROM) including the program recorded thereon.

For example, when the present disclosure is implemented by a program (software), each of the steps is performed as a result of the program being executed by utilizing hardware resources such as a CPU, memory, an input and output circuit, etc. of a computer. In other words, each step is executed by the CPU obtaining data from memory or an input and output circuit, etc., performing calculations, and outputting calculation results to memory or input and output circuit, etc.

It should be noted that, in the above-described embodiments, each of the structural components included in the noise detection device may be configured in the form of a dedicated hardware product, or may be implemented by executing a software program suitable for the structural components. Each of the structural components may be implemented by means of a program executing unit, such as a CPU or a processor, reading and executing the software program recorded on a recording medium such as a hard disk or a semiconductor memory.

Some or all of the functions of the noise detection device according to the foregoing embodiments are typically implemented as LSIs which are integrated circuits. They may be implemented as a single chip one-by-one, or as a single chip to include some or all thereof. In addition, the integrated circuit is not limited to an LSI, and it may be implemented as a dedicated circuit or a general-purpose processor. A field programmable gate array (FPGA) that is programmable after an LSI is manufactured or a reconfigurable processor that is capable of reconfiguring connection and settings of circuit cells inside an LSI may be employed.

Furthermore, in the future, with advancement in semiconductor technology, a brand-new technology may replace LSI. The structural components included in the noise detection device each can be integrated using such a technology.

It should be noted that the present disclosure also includes other forms in which various modifications apparent to those skilled in the art are applied to the embodiments or forms in which structural components and functions in the embodiments are arbitrarily combined within the scope of the present disclosure.

### (Others)

The descriptions of the embodiments described above disclose the following techniques.
(Technique 1) A noise detection device that detects noise contained in an input signal including a carrier wave and a modulation signal. The noise detection device includes: a discrete Fourier transform (DFT) executor that performs a DFT on the input signal and outputs a transform result; a carrier wave detector that detects a carrier wave frequency bin that is a frequency bin containing a component of the carrier wave in the transform result; a frequency corrector that performs a correction to reduce a difference between a center frequency of the carrier wave frequency bin and a frequency of the carrier wave; a phase calculator that calculates a phase of each signal component in a corrected transform result that is the transform result output after the correction; a phase inversion unit that inverts an order of the phase of each signal component with respect to a center frequency of the carrier wave frequency bin in the corrected transform result; and an asymmetric component detector that detects, as noise, a signal component whose phase is asymmetric with respect to the carrier wave frequency bin in the corrected transform result, based on the phase of each signal component before inversion and the phase of each signal component after inversion.

In the transform result of the DFT (frequency spectrum) for an input signal, the components of modulation signals ideally are symmetric in terms of amplitude and phase with respect to the carrier wave frequency bin. On the other hand, although there are instances where noise components are symmetric in terms of amplitude with respect to the carrier wave frequency bin, since noise is a signal that is not synchronized with the carrier wave, the noise components are asymmetric in terms of phase even if they are symmetric in terms of amplitude. In view of the above, it is possible to detect, as noise, a signal component whose phase is asymmetric with respect to the carrier wave frequency bin, by inverting the phase of each signal component which may include noise, with respect to the center frequency of the carrier wave frequency bin in the transform result, and comparing the phase before inversion with the phase after inversion of each signal component. As a result, it is possible to detect noise even when the noise components are present at symmetric positions in the amplitude spectrum.

However, depending on the frequency resolution of a DFT, the carrier wave frequency bin in the transform result of the DFT deviates from the actual frequency of the carrier wave. When the carrier wave frequency bin deviates from the actual frequency of the carrier wave, the components of the modulation signals are not symmetric in terms of phase with respect to the carrier wave frequency bin. As a result, the components of the modulation signals also are asymmetric in terms of phase with respect to the carrier wave frequency bin, which may lead to the components of the modulation signals being falsely detected as noise. In view of the above, by performing correction to reduce the difference between the center frequency of the carrier wave frequency bin and the frequency of the carrier wave, it is possible to reduce the deviation between the carrier wave frequency bin and the actual frequency of the carrier wave. As a result, it is possible to inhibit the components of the modulation signals from being asymmetric in terms of phase with respect to the carrier wave frequency bin, making it possible to inhibit the components of the modulation signals from being falsely detected as noise.

For example, as a noise countermeasure for inverters used in electric vehicles, etc., there is a method of detecting, as noise, a component appearing in an orthogonal component, by utilizing the fact that the components of broadcast signals are concentrated in the in-phase component when an AM signal is synchronously detected, as described in U.S. Pat. No. 11,277,287. However, this method requires an LPF or a PLL to extract the carrier wave for synchronous detection, leading to an increase in processing costs. On the other hand, according to the present disclosure, since correction is performed by calculation from the carrier wave detected by a DFT, an LPF or a PLL is not required, making it possible to reduce processing costs.
(Technique 2) The noise detection device according to Technique 1, in which the carrier wave detector detects a phase of the carrier wave in the transform result, and the frequency corrector performs the correction based on the phase of the carrier wave.

When the carrier wave frequency bin deviates from the actual frequency of the carrier wave, the component of the carrier wave frequency bin rotates (i.e., a phase error occurs) for each frame when the component is displayed in complex notation. In view of the above, by detecting the phase of the carrier wave and performing correction to inhibit a phase error, it is possible to reduce the difference between the center frequency of the carrier wave frequency bin and the frequency of the carrier wave.
(Technique 3) The noise detection device according to Technique 2, in which the frequency corrector performs the correction by performing on the transform result a convolution operation based on the phase of the carrier wave.

In this manner, by performing a convolution operation in the frequency domain, it is possible to perform correction to inhibit a phase error.
(Technique 4) The noise detection device according to Technique 2, in which the frequency corrector performs the correction by adjusting a phase of the input signal to reduce the phase of the carrier wave.

In this manner, it is possible to perform correction to inhibit a phase error, by adjusting the phase of the input signal in the time domain.
(Technique 5) The noise detection device according to Technique 4, in which the DFT executor performs a discrete Fourier transform (DFT) on the input signal with the phase adjusted by the correction, and the carrier wave detector detects the carrier wave frequency bin in the corrected transform result, and detects the phase of the carrier wave after subtracting an amount of phase adjustment in the correction.

The amount of phase adjustment of the input signal in the time domain in the frequency corrector is information obtained by calculation in the noise detection device, and thus the processing in the frequency corrector is performed before the processing in the DFT executor, and when detecting the phase (specifically, the phase error) by the carrier wave detector, the amount of phase adjustment in the frequency corrector is subtracted, thereby making it possible to unify the DFT executor used for detecting a carrier wave and the DFT executor used for detecting noise.
(Technique 6) A noise suppression device including: the noise detection device according to any one of Techniques 1 to 5; a suppression coefficient calculator that calculates a suppression coefficient for suppressing an amplitude of the signal component detected as the noise; and an inverse discrete Fourier transform (IDFT) executor that performs an IDFT on the corrected transform result multiplied by the suppression coefficient, and outputs an output signal.

With this configuration, it is possible to detect noise contained in an input signal, and output an output signal with noise suppressed. For example, even in the cases where it is difficult to detect a carrier wave, such as when there is significant noise in proximity to the frequency of a carrier wave or when a sudden large pulse noise is applied, it is possible to achieve suppression equivalent to that of conventional methods, by suppressing only the detection portion of an amplitude difference, thereby making it possible to suppress a decrease in the suppression function.
(Technique 7) The noise suppression device according to Technique 6, further including: a frequency inverse corrector that performs an inverse correction that reverts a difference between a center frequency of the carrier wave frequency bin and a frequency of the carrier wave in the corrected transform result multiplied by the suppression coefficient, back to a state before the correction.

There are instances where a signal variation occurs due to a variation in the correction amount of the correction by the frequency corrector. In view of the above, by performing inverse correction of such correction, it is possible to suppress the effects of such signal variation. In addition, when the frame length and the data processing unit do not match, there are instances where the phase rotates depending on the carrier position. For example, when performing an FFT with a shift of ½ frame, if the carrier position deviates by 1 bin from the center, the data of the next frame starts from a position rotated by ½×360°, and thus the phase appears to rotate by 180° for each frame. In this case, when the phase of the carrier wave frequency bin is aligned to 0°, the phase is inverted for each frame at the time of coupling after the IDFT. Accordingly, it is not possible to perform coupling correctly. Even in such a case, it is possible to couple the signals correctly by performing inverse correction by the frequency inverse corrector.
(Technique 8) A noise detection device that detects noise contained in an input signal including a carrier wave and a modulation signal. The noise detection device includes: a discrete Fourier transform (DFT) executor that performs a DFT on the input signal and outputs a transform result; a carrier wave detector that detects a carrier wave frequency bin that is a frequency bin containing a component of the carrier wave in the transform result; a phase calculator that calculates a phase of each signal component in the transform result; a phase inversion unit that inverts an order of the phase of each signal component with respect to a center frequency of the carrier wave frequency bin in the transform result; and an asymmetric component detector that detects, as noise, a signal component whose phase is asymmetric with respect to the center frequency of the carrier wave frequency bin in the transform result, based on the phase of each signal component before inversion and the phase of each signal component after inversion.

In the transform result of a DFT (frequency spectrum) on input signals, the components of modulation signals are ideally symmetric in terms of amplitude and phase with respect to the carrier wave frequency bin. On the other hand, although there are instances where noise components are symmetric in terms of amplitude with respect to the carrier wave frequency bin, the noise components are asymmetric in terms of phase even when they are symmetric in terms of amplitude since noise is a signal that is not synchronized with the carrier wave. IIn view of the above, it is possible to detect, as noise, a signal component whose phase is asymmetric with respect to the carrier wave frequency bin, by inverting the phase of each signal component which may include noise, with respect to the center frequency of the carrier wave frequency bin in the transform result, and comparing the phase of each signal component before inversion with the phase of each signal component after inversion. As a result, it is possible to detect noise even when the noise components are present at symmetric positions in the amplitude spectrum.
(Technique 9) A noise detection method performed by a noise detection device for detecting noise contained in an input signal that includes a carrier wave and a modulation signal. The noise detection method includes: performing a discrete Fourier transform (DFT) on the input signal and outputting a transform result; detecting a carrier wave frequency bin that is a frequency bin containing a component of the carrier wave in the transform result; performing a correction to reduce a difference between a center frequency of the carrier wave frequency bin and a frequency of the carrier wave; calculating a phase of each signal component in a corrected transform result that is the transform result output after the correction; inverting the phase of each signal component with respect to a center frequency of the carrier wave frequency bin in the corrected transform result; and detecting, as noise, a signal component whose phase is asymmetric with respect to the carrier wave frequency bin in the corrected transform result, based on the phase of each signal component before inversion and the phase of each signal component after inversion.

With this, it is possible to provide a noise detection method capable of detecting noise even when the noise components are present at symmetric positions in the amplitude spectrum.
(Technique 10) A non-transitory computer-readable recording medium having recorded thereon a computer program for causing a computer to execute the noise detection method according to Technique 9.

With this, it is possible to provide a recording medium capable of detecting noise even when the noise components are present at symmetric positions in the amplitude spectrum.

### INDUSTRIAL APPLICABILITY

The present disclosure is applicable to devices that suppress nose contained in a broadcast wave, etc.

1. A noise detection device that detects noise contained in an input signal including a carrier wave and a modulation signal, the noise detection device comprising:
a discrete Fourier transform (DFT) executor that performs a DFT on the input signal and outputs a transform result;
a carrier wave detector that detects a carrier wave frequency bin that is a frequency bin containing a component of the carrier wave in the transform result;
a frequency corrector that performs a correction to reduce a difference between a center frequency of the carrier wave frequency bin and a frequency of the carrier wave;
a phase calculator that calculates a phase of each signal component in a corrected transform result that is the transform result output after the correction;
a phase inversion unit that inverts an order of the phase of each signal component with respect to a center frequency of the carrier wave frequency bin in the corrected transform result; and
an asymmetric component detector that detects, as noise, a signal component whose phase is asymmetric with respect to the carrier wave frequency bin in the corrected transform result, based on the phase of each signal component before inversion and the phase of each signal component after inversion.

2. The noise detection device according to claim 1, wherein
the carrier wave detector detects a phase of the carrier wave in the transform result, and
the frequency corrector performs the correction based on the phase of the carrier wave.

3. The noise detection device according to claim 2, wherein
the frequency corrector performs the correction by performing on the transform result a convolution operation based on the phase of the carrier wave.

4. The noise detection device according to claim 2, wherein
the frequency corrector performs the correction by adjusting a phase of the input signal to reduce the phase of the carrier wave.

5. The noise detection device according to claim 4, wherein
the DFT executor performs a DFT on the input signal with the phase adjusted by the correction, and
the carrier wave detector detects the carrier wave frequency bin in the corrected transform result, and detects the phase of the carrier wave after subtracting an amount of phase adjustment in the correction.

6. A noise suppression device comprising:
the noise detection device according to claim 1;
a suppression coefficient calculator that calculates a suppression coefficient for suppressing an amplitude of the signal component detected as the noise; and
an inverse discrete Fourier transform (IDFT) executor that performs an IDFT on the corrected transform result multiplied by the suppression coefficient, and outputs an output signal.

7. The noise suppression device according to claim 6, further comprising:
a frequency inverse corrector that performs an inverse correction that reverts a difference between a center frequency of the carrier wave frequency bin and a frequency of the carrier wave in the corrected transform result multiplied by the suppression coefficient, back to a state before the correction.

8. A noise detection device that detects noise contained in an input signal including a carrier wave and a modulation signal, the noise detection device comprising:
a discrete Fourier transform (DFT) executor that performs a DFT on the input signal and outputs a transform result;
a carrier wave detector that detects a carrier wave frequency bin that is a frequency bin containing a component of the carrier wave in the transform result;
a phase calculator that calculates a phase of each signal component in the transform result;
a phase inversion unit that inverts an order of the phase of each signal component with respect to a center frequency of the carrier wave frequency bin in the transform result; and
an asymmetric component detector that detects, as noise, a signal component whose phase is asymmetric with respect to the center frequency of the carrier wave frequency bin in the transform result, based on the phase of each signal component before inversion and the phase of each signal component after inversion.

9. A noise detection method performed by a noise detection device for detecting noise contained in an input signal that includes a carrier wave and a modulation signal, the noise detection method comprising:
performing a discrete Fourier transform (DFT) on the input signal and outputting a transform result;
detecting a carrier wave frequency bin that is a frequency bin containing a component of the carrier wave in the transform result;
performing a correction to reduce a difference between a center frequency of the carrier wave frequency bin and a frequency of the carrier wave;
calculating a phase of each signal component in a corrected transform result that is the transform result output after the correction;
inverting the phase of each signal component with respect to a center frequency of the carrier wave frequency bin in the corrected transform result; and
detecting, as noise, a signal component whose phase is asymmetric with respect to the carrier wave frequency bin in the corrected transform result, based on the phase of each signal component before inversion and the phase of each signal component after inversion.

10. A non-transitory computer-readable recording medium having recorded thereon a computer program for causing a computer to execute the noise detection method according to claim 9.
